(19) United States
(12) Patent Application Publication
(10) Pub. No.: US 2003/0069882 A1
(43) Pub. Date: Apr. 10, 2003

(54) Context sensitive method for data retrieval from databases

(76) Inventors: Benno Nieswand, Konstanz (DE); Edward A. Ross, Bristol (GB)

Correspondence Address: John S. Reid, Reidlaw, L.L.C., 1926 S. Valleyview Lane, Spokane, WA, 99212-0157, US

(21) Appl. No.: 10/256,544

(22) Filed: Sep. 28, 2002

(30) Foreign Application Priority Data
Oct. 4, 2001 (EP) EPO 01123 808.6-1

(51) Int. Cl. G06F 17/30

(52) U.S. Cl. 707/5

(57) ABSTRACT

A computer-based, context sensitive method for finding and retrieving database results from arbitrarily structured databases with data records includes entering or changing a character string in a current input window, and transmitting the character string to a search algorithm for searching the database. A search result is outputted in the form of an identical or approximate matching list of candidates, where immediately after the input of a character string in the current input window, a list of candidates with appropriate close candidates for the current input window is proposed in a candidate field. A list of suggestions for the character string in the suggestion field is generated. A context restriction is specified by choosing, either in the generated field of candidates or in the generated suggestion field, and the input fields are subsequently filled-in with the appropriate results. Partial or complete suggestions are output within the suggestion field using all the information contained in the available list of candidates. Selected steps are then repeated.

### TECHNICAL BASIS IDEA

The invention describes a computer implemented, context sensitive method for finding and retrieving database results from arbitrarily structured databases containing data records.

### BACKGROUND

Definitions of Terms

Database

The term database used herein is an arbitrarily structured collection of data that are associated with corresponding addressable fields, where the database is structured horizontally and vertically. A record is a horizontally ordered set of information associated with these fields.

Character String

The term “character string” refers to a sequence of characters, for instance, letters or digits, which are to be entered by the user in specified input windows, represented on the screen as structured form. Generally, several such input windows will be used, where character strings can be input, as well as where character strings can put generated via the applications of programs. The input windows are associated with intended data material, e.g. Names of people, streets, locations, bank codes etc. The current input window will typically be activated via cursor positioning.

Field of Candidates/List of Candidates

The term “field of candidates” refers to a field in an input form on the screen which contains the candidates associated with the current input field. This means that the data shown in the field of candidates corresponds to the vertical representation of a data field in a database. In other words, only a selected field of the entire data record that is related to the string occurring in a valid and selected input field will be shown. A list of candidates shows the candidates in a field of candidates (**).

Suggestion Field/Suggestion List

Another field making up the presentation on the screen contains a list of suggestions in a suggestion field; the suggestion list consists of a sequentially ordered row of parts of several data records. This means that a horizontal selection of the database is being represented here which contains at least some of the fields making up a data record. The list of suggestions thus contains at least one suggestion that can be understood as a partial result or even the complete result for the query in question.

Context

A context is a subset of the set of records in a database which are in general defined as character strings in the input fields. A context is principally used to evaluate the candidate list, for instance with a colored marking. The marking indicates whether the chosen candidates are inside or outside the context or not yet identifiable.

### STATE OF THE ART

Database applications abound in many areas of business and commerce. Due to commercial transactions, searches or similar activities it is often necessary to look for Information in large data sets. To this end, a variety of software programs are being used that offer such search functionalities as software solutions. The function of these software modules is to inspect the data sets and to provide the relevant search results.

Searching in large data sets is most often performed in a sequential manner. The user, that is, the searcher, asks a query in that he provides (off-line or online) a search profile in a specified query language, for instance, Messenger. An alternative might also be to fill out some forms, as we know them from search engines, in which the fields of the database in which the search is to take place are specified. In addition, the keywords in the query can be combined or related to the search fields via the use of operators, in particular, Boolean operators. The query expression thus formulated is then forwarded to the program via an enter command; the program then translates the search request into the underlying search syntax of the software. The translated query is then passed on to the database software, which then returns a search result in the form of a list of hits. This list of hits is typically ordered, indicating the quality of the individual results: appropriate, less appropriate, inappropriate. This list can then be perused by the user, that is, the searcher, who can then decide which of the hits are really relevant for him.

If it turns out for instance that the result does not the requested properties, the user can reformulate his search profile in a different manner. The user will generally have the possibility either to improve upon the current search profile by extending it with logical operators or to abandon the current profile and initiate an entirely new profile instead.

In general, the user is always obliged to examine the result provided for his query in a sequential manner, i.e. to look at each search result in turn and to draw the appropriate conclusions in order to derive a new search strategy. In the way, an iteratively derived search result can certainly be obtained, it is however relatively laborious to repeat these steps over and over again in order to come to the intended result.

Moreover, this means that the user has to completely execute and analyze a search before he start to optimize it and to run it again. It is very common that users have to devise completely new search profiles each time and to examine the results over and over again to check whether the information they seek is among them.

### SUMMARY

The goal of the invention to provide a procedure of the kind mentioned above that allows for structured search in data sets of arbitrary size in an efficient, comfortable and interactive manner.

Solutions Provided by the Invention

One solution provided by the present invention provides for a method, and use of the method, having the following features:

a) Entering or changing a character string in the current input window;

b) Transmission of the character string to a search algorithm for searching the database;

c) Output of the search result in identical or approximate matching, in the form of list of candidates, whereby immediately after the input of a character string in the current input window a list of candidates with appropriate close candidates for the current input window is proposed in a candidate field;

d) Generation of a list of suggestions for the character string in the suggestion field (**);

e) Specification of a context restriction by choosing, either in the generated field of candidates or in the generated suggestion list, and subsequent filling in of the input field with the appropriate results;

f) Output of partial and complete suggestions within the suggestion field using all the information contained in the available list of candidates;

g) Repetition of one of the steps a-d, or only of step d or only of step e followed by step f or only of step f.

The basic idea of the invention is that the user can perform his search within a self-defined context, which he can change at any time, thus having at all times the possibility to “look beyond” the current context. This allows both a horizontal as well as a vertical inspection of the database.

### ADVANTAGES OF THE INVENTION

One of the central advantages of the invention is that the user of this procedure underlying the present invention is not restricted in his strategies for the incremental refinements of the relevant part of the database. He is completely free in his choice of which input fields to fill in, which candidates to select or which suggestion lists to accept in order to continue by filling in further character strings in input fields. The procedure allows for continual refinement of the generated data and leads to the correct database record in a quick and efficient manner.

A further central advantage of the procedure documented in this invention is that every input provided by the user is recorded and saved, such that it is at all times very easy to retrace any sequence of searches. The user is free at every search step to make any of the input fields the current input field and to continue searching with new input from here.

Enabling to search both horizontally and vertically in structured databases, the procedure documented in this invention leads the user quickly and very efficiently, even in the setting of very large data sets, to the intended result even when there is no precise initial formulation of the character strings being looked for.

Additional input fields make it possible in a very simple way to determine the degree of approximation with which the list of candidates, generated in connection with the current input field, are to be represented.

Additional features indicate in the list of suggestions or in the candidate field the quality, e.g. 100% matches, of the members of the hit list.

The procedure itself is realized in the form of software, consisting of an application interface (Client) intended as an interface for data input and a data server (Server), that are connected directly or via communication channels (e.g. the internet) with each other. It is therefore possible that intermediary results can be stored on the server, thus remaining accessible any time for recall. There are also mechanisms which allow for the generation of results even after the input of partial strings, generating completions of character strings on a character by character basis. Further suggestive tools can be used to characterize lists of candidates or suggestion lists by marking these in different colors, so that the users can see right away, which results are context compatible, which are not context compatible or for which results it cannot yet be decided if they are context compatible or not.

The various input fields are equipped with appropriate indicators that specify for instance by a black color that a context is defined, by green that at least one suggestion in the candidate list or suggestion list is available, and by orange that there are existing candidates which do not fit the context. The color red indicates that no hit was found for the query.

It is in general not necessary that the user activate his input, i.e. the search or the search strategy, by clicking on ENTER or another specific control element. Every input in one of the relevant input fields immediately triggers a search so that the user is always in control of what is generated, i.e. of which input leads to which result.

Further advantageous features can be inferred from the following descriptions, from the drawings as well as from the claims.

### DESCRIPTION OF THE DRAWINGS

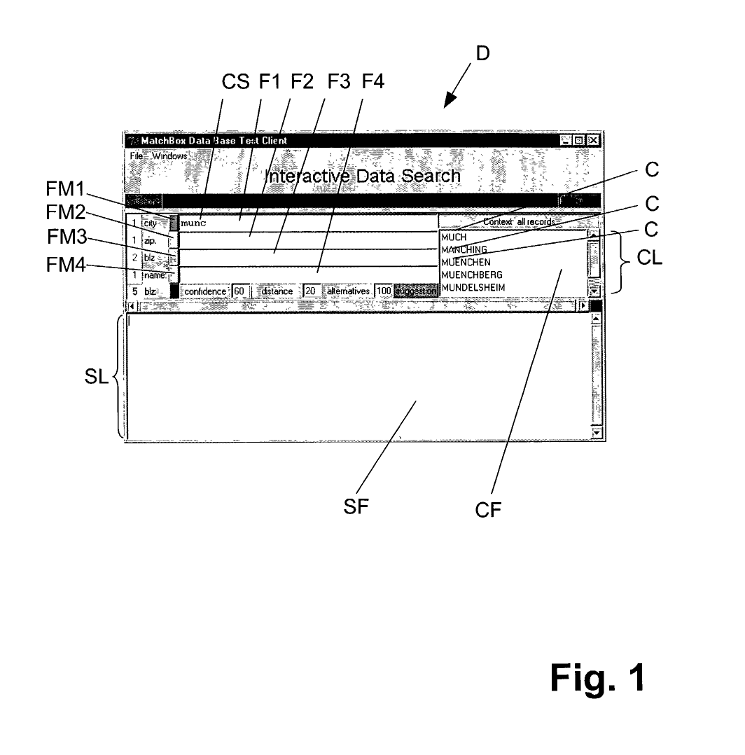

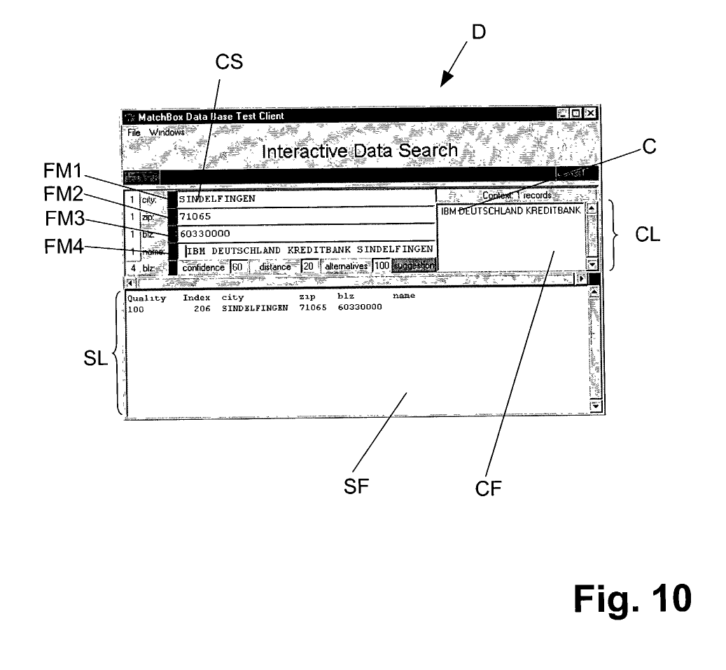

The FIGS. 1-10 illustrate different execution steps that can be performed in interactive searching according to embodiments of the present invention.

### DETAILED DESCRIPTION

FIG. 1 shows the data input and data output mask D of a client.

The fields F1, F2, F3 and F4, which are intended as input and output fields are empty after initializing the client. In the running example the fields F1-F4 are associated with city (CITY), zip code (ZIP), bank number (BLZ) and name (NAME).

With the input of a character string CS with the characters “MUNC” in the field F1 (CITY) a first search is initialized. This leads to the generation of a candidate list CL that correspond at least approximately to the original character string CS in the candidate field D in the data input and output mask.

In so far as there are candidates C in the candidate list CL, the field state feature FM1-FM4 of the fields F1-F4 will change accordingly.

In FIG. 1 the field state feature FM1 of the field F1 indicates that at least one candidate C is in the list of candidates CL.

The suggestion field SF in the data input and output mask D remains empty, since no relevant context has yet been selected from the list of candidates CL.

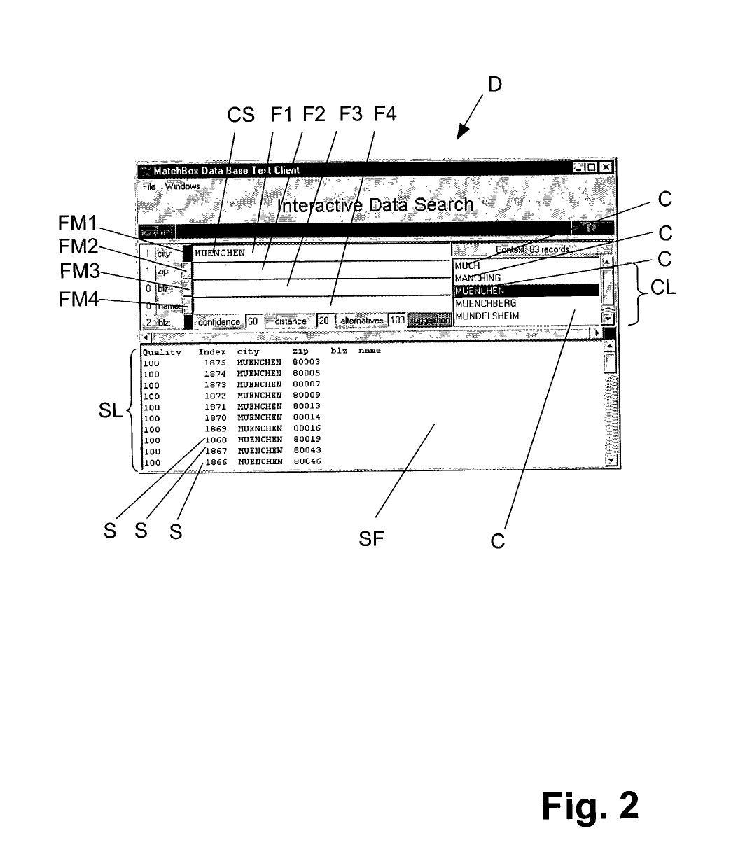

In FIG. 2 the user selects a context from the candidate list CL by clicking on the character string in the candidate list CL. By clicking on the selected character string in the running it is inserted in field F1 and the corresponding field state feature FM1 changes to context compatible. As a result the corresponding suggestion field is filled in with suggestion list SL consisting of suggestions S and presented as a partial result.

In the present case, the character string “MUENCHEN” has been selected from the list of candidates CL and inserted in field F1. Thus, after the database has been searched vertically on the basis of the presented list of candidates and an appropriate context has been selected, a list of suggestions SL with suggestions S is generated horizontally from the database in accordance with the selected context. In the present example, all zip codes of the city of Munich are listed.

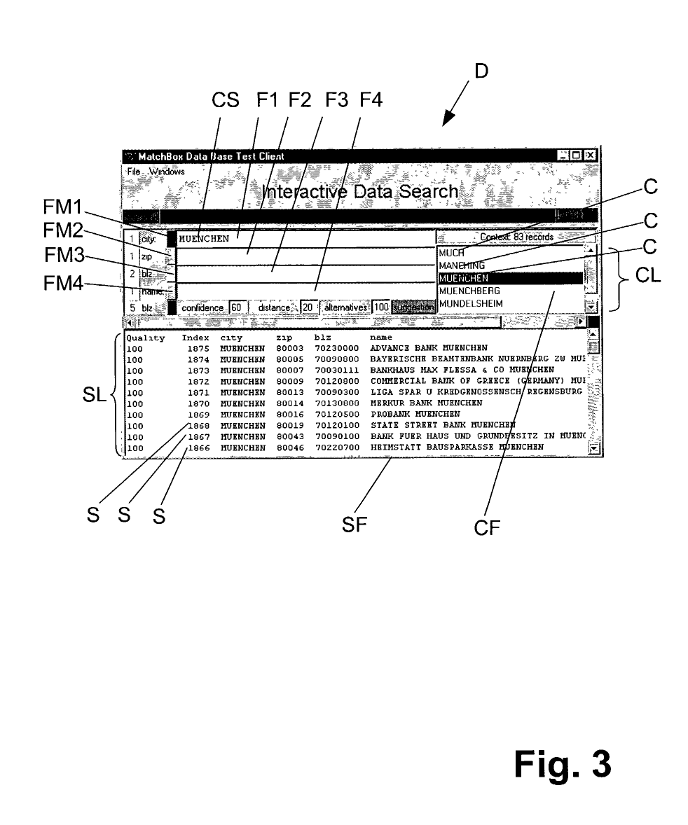

In a further step, as illustrated in FIG. 3, the suggestion list SL is completed by showing all names that fit the corresponding zip codes and bank codes. As a result we have a complete listing of the horizontal dimension of the database relating to the candidate “MUENCHEN”.

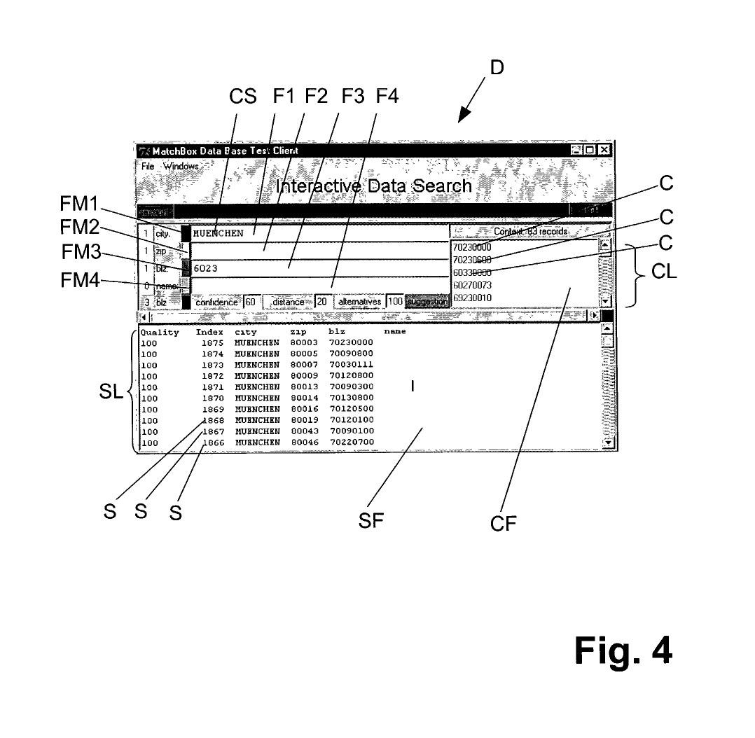

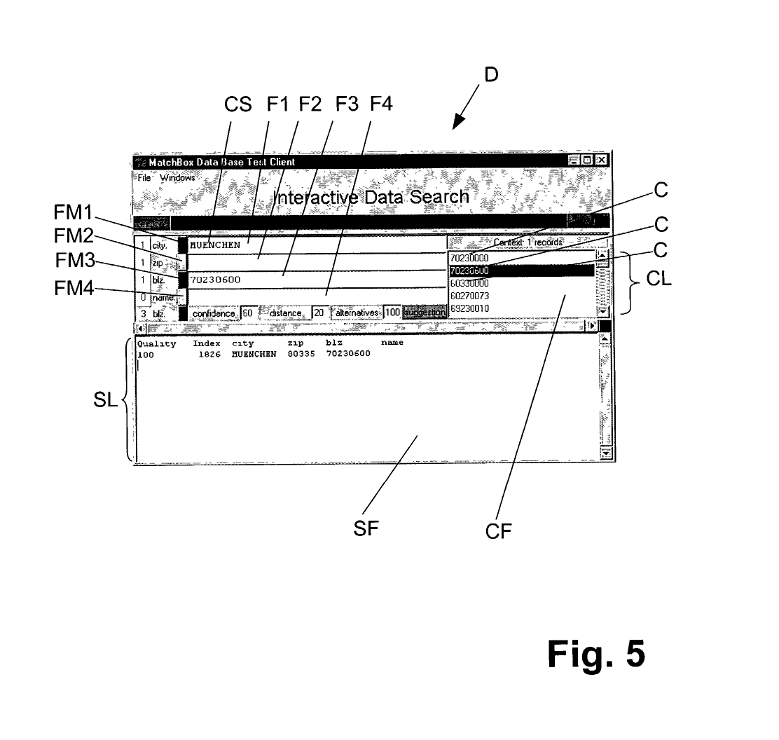

In a further step the user decides, in field 3 as depicted in FIG. 4, to enter a bank code. Corresponding to the procedure underlying the invention represented in FIGS. 1 and 2, the candidate list CL generated so far is erased and a new candidate list CL for field 3 is shown. Here as well, the candidates C are listed on the basis of their approximate nearness and the field state feature FM of the current input field F is set. In the present case, the field state feature gets the color green, which is tantamount to having found many candidates C and that these are compatible with the context, here defined as consisting of the entity Munich. If the user chooses an appropriate candidate C from the candidate list CL, as indicated in FIG. 5, the corresponding suggestion list SL shows the suggestions S. In the present case there is only one hit that agrees in the bank code as well as with the city.

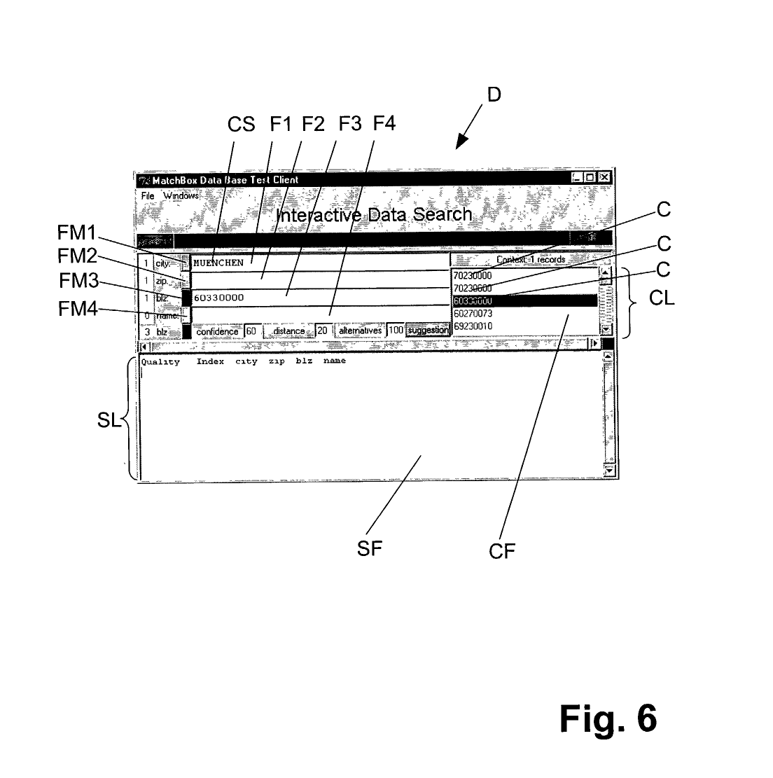

If the user chooses another bank code from the candidate list CL, as depicted in FIG. 6, then he specifies a new context and the field state feature FM3 changes accordingly. In the present case, a so-called “broken context” has resulted. This means that the input given in fields F1 and F3 does not get a suggestion list SL with appropriate suggestions S.

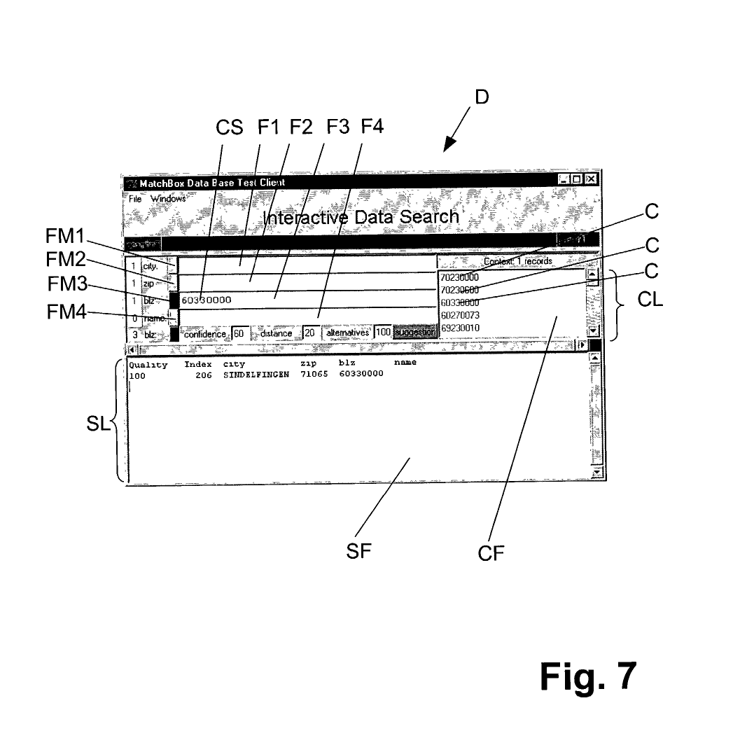

If the user defines a new context and erases the remaining inputs in the other fields, as depicted in FIG. 7, we get a new candidate list CL from which a new appropriate candidate C may be selected.

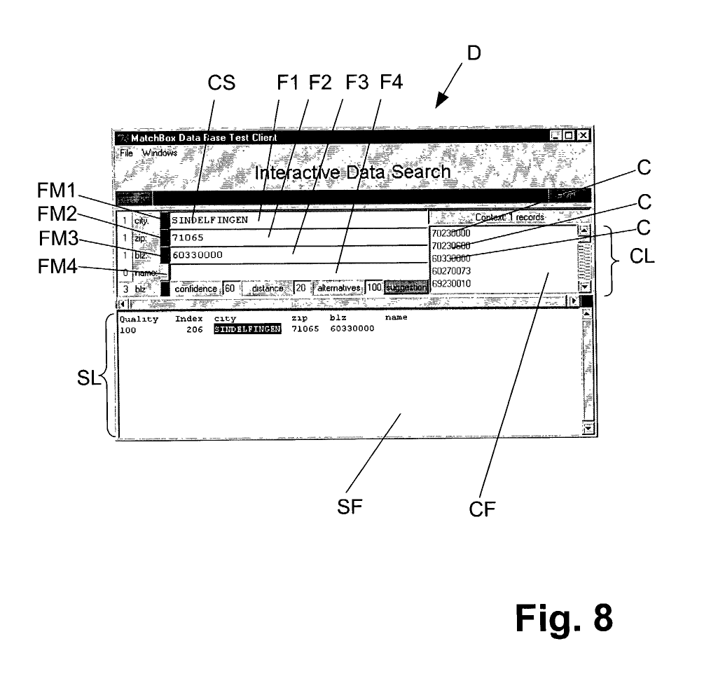

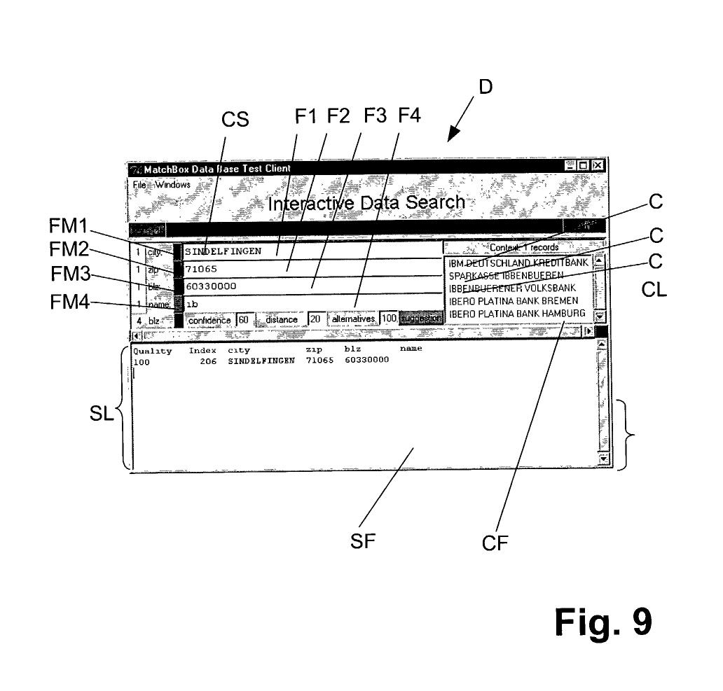

As shown in FIG. 8, the user is now free to select any element from the suggestion list SVL, as illustrated in FIG. 7. In the present case he chooses for the concept city (CITY) (here “Sindelfingen”) and the fields F1-F3 will be filled with the horizontally represented results in accordance with the suggestion list SL. In this way the context for the fields F1, F2 and F3 is specified. Solely field F4 (NAME) has not been filled in by the user and as shown in FIG. 9 an appropriate input from the user is expected. If no input is specified, there is also the possibility to generate a suggestion list SL with all names by clicking on the field F4.

As shown in FIG. 9 the user chooses to insert a part of a character string CS in field F4. As already illustrated in FIG. 1, the candidate list CL relative to field F4 (the current field) is generated. The user may now choose an appropriate candidate C from the candidate list CL. In the present case, the candidate C is the string “IBM Deutschland Kreditbank”. The corresponding field state feature FM4 indicates in terms of the color of the field that a context compatible candidate C has been chosen. As soon as all fields have received the appropriate field state feature, the hit represented in the suggestion list SL (also now the result list) is found.

In addition, the selection switch S can be used to choose among various presentation forms in particular with respect to the suggestion list SL (for example on presentation of bank codes only).

The structure of a database search in accordance with the present method is characterized among other things by the fact that at the beginning of every new data search a new data structure is initialized; this structure stores the entire search process and makes it available to further processes. The client receives a so-called identifier for the initialized session, which must be specified in all subsequent requests. Using well-known security mechanisms (public and private keys) it can be guaranteed that only the initializing client has access to the data of the current session.

Requests to the server (input in the corresponding fields F1-F4) change the content of this structure. At the same time, the server sends a subset of the information back to the requesting client (generation of the candidate list CL and the suggestion list SL).

Only as much information concerning a request in a history structure (**) as is needed to reproduce the intermediary results are stored, not necessarily all results.

Only as much information concerning a request as is needed to reconstruct the intermediary results is stored in a history structure, not necessarily all the results themselves. The data structure used to store the intermediary states of a search can be erased any time by the client. A history structure stores at least every change in an input character string, every mode, every partial query, every selection in a list. By traversing this structure, it is at any moment possible to reproduce every intermediary result and as a result to reproduce every state of the context. The user can traverse the history both forwards and backwards as needed.

The procedure underlying the invention is applicable to practically any database structure and is useful in those areas where search on the basis of traditional methods (sequentially) turns out to be laborious. This technology is applicable to the following areas, although this is not an exhaustive enumeration and is not intended to restrict the scope of the invention.

Database quality management and Call-Center applications, in particular, address data, contact information, registration databases, customer lists, where the typical fields are cities and city parts, streets, company names and house numbers. Other application areas are to be found in library settings and library search (author lists, category search, key word search), ware housing and logistics, data flow, goods flow, post automation (video workplace), telecommunication information, e-commerce, web catalogues, document management systems, archives, operating systems and file search.

TABLE 1
REFERENCE LIST OF SIGNS

| | |
|---|---|
| D | Data Input and Output Mask |
| CS | Character String |
| F1-F4 | Input Fields |
| FM | Field State Marker |
| C | Candidate |
| CL | Candidate List |
| CF | Candidate Field |
| S | Suggestion |
| SL | Suggestion List |
| SF | Suggestion Field |

1. Computational context-sensitive method for data retrieval and querying for database results from arbitrarily structured databases with data records, characterized by the following procedural steps:
a) Entering or changing a character string (CS) in the current input window (F1-F4);
b) Transmission of the character string (CS) to a search algorithm for searching the database;
c) Output of the search result in identical or approximate matching, in the form of list of candidates (CL), whereby immediately after the input of a character string (CS) in the current input window (F1-F4) a list of candidates (CL) with appropriate close candidates(C) for the current input window (F1-F4) is proposed in a candidate field (CF) and
d) Generation of a list of suggestions (SL) for the character string (CS) in the suggestion field (SF);
e) Specification of a context restriction by selection, either in the generated field of candidates (CF) or in the generated suggestion field (SF), and subsequent filling in of the input field (F1-F4) with the appropriate results;
f) Output of partial or complete suggestions (S) within the suggestion field (SF) using all the information contained in the available list of candidates (CL);
g) Repetition of one of the steps a-d, or only of step d or only of step e followed by step f or only of step f.

2. Procedure as described in claim 1, characterized by presentation of a candidate list (CL) in terms of context compatible, not context compatible or not yet decided

3. Procedure as described in at least one of the previous claims, characterized by the fact, that the suggestion list (SL) is marked in terms of context compatible, not context compatible or not yet decided.

4. Procedure as described in at least one of the previous claims, characterized by the fact that a free choice of the combination of the input fields (F1-F4) and their candidates (C) is possible.

5. Procedure as described in at least one of the previous claims, characterized by the fact that the procedure is based on the client-server principle.

6. Use of a computer-based, context sensitive method for finding and retrieving database results from arbitrarily structured databases with data records as a search engine as described in claim 1 for data sets that comprise addresses and/or telephone numbers.

7. Use of a computer-based, context sensitive method for finding and retrieving database results from arbitrarily structured databases with data records as a search engine as described in claim 1 for data sets on the internet and in intranets.

8. Use of a computer-based, context sensitive method for finding and retrieving database results from arbitrarily structured databases with data records as a search engine as described in claim 1 for data sets for file search in data storage.
